(19) United States
(12) Patent Application Publication
(10) Pub. No.: US 2005/0267864 A1
(43) Pub. Date: Dec. 1, 2005

(54) Automated system and methods for determining relationships between information resources

(75) Inventors: Cameron Pope, Denver, CO (US); Zach T. Nies, Arvada, CO (US)

Correspondence Address: COCHRAN FREUND & YOUNG LLC, 2026 CARIBOU DR, SUITE 200, FORT COLLINS, CO, 80525, US

(73) Assignee: Ralston Technology Group, Inc., Arvada, CO (US)

(21) Appl. No.: 11/197,147

(22) Filed: Aug. 3, 2005

Related U.S. Application Data
(63) Continuation of application No. 10/260,173, filed on Sep. 27, 2002, now abandoned.
(60) Provisional application No. 60/346,795, filed on Jan. 7, 2002.

(51) Int. Cl. G06F 17/30

(52) U.S. Cl. 707/1

(57) ABSTRACT

A system for determining relationships between information resources. The system of this preferred embodiment is able to determine relationships between information resources by both explicit means through similarities in characteristics and content of the information resources and by inferring relationships by other similarities, including but not limited to indirect data, observations, attributes, assumptions and other means.

### RELATED APPLICATIONS

This application is a continuation of United States patent application Ser. No. 10/260,173 filed 27 Sep. 2002, which in turn claims priority from U.S. provisional patent application No. 60/346,795, filed on Jan. 7, 2002.

### FIELD OF THE INVENTION

This invention relates generally to methods and systems for organizing access to resources and materials, particularly in a computerized environment. More particularly, it is directed at providing support for the activities of a user interacting with a number of entities which may potentially be related to a given activity.

### BACKGROUND OF THE INVENTION

The organization of information is ever increasing becoming more critical and more complex in the computerized environment that most people operate in today. Individuals and organizations are bombarded with information from a multiplicity of sources, ranging from written documents, electronic files, emails, telephone calls, wireless data assistants, and so forth. It is the rare individual that is able to efficiently maintain the resources containing information in an organized manner for ease of access. Further, the need for obtaining access to this information is typically in a environment requiring immediate access.

Efforts to organize information regardless of the form of the resources containing this information is essentially accomplished by providing structure, by grouping items deemed to be related, by noting or creating salient relationships between items, and by choosing some features or interactions or relationships or structures to be more important than others in determining interactions with the world around us. The solutions to the problem are not straightforward, as evidenced by the many alternative methods proposed for providing useful methods for organizing, and by the difficulties most people have in setting up, maintaining, and using organizing systems.

Many of the difficulties in finding suitable methods for organizing resources arise from the complexity of the computerized environment compared to the organizational structures used to manage the resources. Even when the focus is on a particular activity or subject area, the entities and interactions involved, and the relationships between them, are invariably more complex, numerous, and highly varied in their characteristics than the organizational schemes developed to capture them. Moreover, the set of interactions, relationships, and entities associated with any given focus is unlikely to be static. These can be expected to change with time, circumstance, point of view, context, and other dynamics. As a result, the utility of any given organizational scheme will tend to vary with such changes as well.

The availability and use of a multiplicity of devices in a computerized environment, by design, provide a common environment for many different types of activity. As a result, users of personal, handheld or other types of computers typically engage in multiple activities, sometimes more or less simultaneously, on a single multipurpose device, generating large amounts of data and interacting with many different entities of different kinds in different formats and locations.

Typically, users in such computerized environments are likely to work with multiple types of information resources such as files, persons, messages, records, and data, even while working on a common activity focus. The resources themselves may be created by disparate software programs or be different types of output created by the same program. The storage location, format (e.g., compressed or uncompressed, encrypted or unencrypted), and accessibility of output can also vary widely, both within and between output types. For a given activity focus, the individual actions and interactions associated with entities, can also be numerous and varied. Additional complexity can arise from the fact that an individual's activity may also be linked to the activities and interactions of others, who may be collaborating with the individual and sharing the same or overlapping foci to varying extents.

Compounding the above difficulties is the fact that most individuals have more than one activity focus, even within the context of a single role or a single project. These days, for example, it is quite common for individuals to have multiple roles in their work and personal lives, working on several different activities or different levels within a given activity, with multiple potential activity foci at any given time, place, or context. A common scenario is for a given individual to be working on several projects or several aspects of a single project at once, managing multiple priorities and switching from focus to focus as changes in circumstances or priorities require. Often, the pace of contemporary life requires that individuals reorient rapidly to changes in focus or priorities, which can be difficult given the complexity of their activities and the numerous resources and interactions involved. In general, it takes time for individuals to reorient themselves to changes in context, even if they are returning to a context that should in fact be familiar. The difficulty of reorienting oneself to a different focus is further exacerbated when the information associated with a particular focus is associated or stored with different places, persons, or applications. Typically the resources further differ in the manner in which they are created, stored, and accessed. The difficulty becomes even greater when the change in focus involves returning to projects left dormant for periods while other projects have been active, or when the need to shift priorities and focus is unpredictable or at least partly beyond the control of the individual.

Previous Methods of Organizing Access for Computerized Environments

In general, the most well-understood approach to organizing access is based on the grouping or identification of related items or representations of those items. In the realm of physically manipulable objects, physical and sometimes temporal collocation is the typical method used to group items that may be related by activity, function, subject matter, structure, or other focus. In the computerized environment, examples of efforts to collocate items relating to a common focus include electronic folders, contact management software, dedicated devices or information appliances for special functions, and the notion of “default folders” for software applications, many of which tend to collocate all output in a common electronic directory unless otherwise specified. In cases where multiple methods for organizing the materials are desirable, or in cases where the entities to be organized cannot or should not be collocated, an indexing approach may be used, where representations of items, or sometimes pointers to them, are grouped rather than the items themselves. While this latter method is often associated with computerized methods for organizing information, it, too, originates from attempts to organize objects and information in the non-computerized world.

In computerized environments, methods for providing organized access to information resources have two basic aspects: (1) the preparation of information so that it can be made accessible, and (2) the retrieval and presentation of information (or pointers to it) in order to make it available to users. Note that many software applications have features that provide some level of organized access to information, even if organizing information is not a primary feature of the applications.

With respect to methods to prepare information for the provision of organized access, existing methods fall into roughly three categories. Many applications that incorporate organizing functions may use one or more of these approaches, as well as incorporating more than one method for some or all of the approaches used. The three basic approaches are:

The application provides means to allow the user to set up his or her own meaningful organizational structures.

Directory management applications, such as Windows Explorer, fall most obviously into this category, as do software applications with features that allow one to manage information produced by the application (e.g., Microsoft Outlook). Database management programs and spreadsheet applications also provide users with opportunities to set up their own meaningful organizational structures for information. Another class of tools of this type are outliners and mind-mapping software, which are used as tools to assist users in forming useful groupings of ideas, information, and information resources. Many applications using this approach incorporate features that allow users to make and view links to documents, applications, web sites, or other resources from within the application.

Many existing organizing tools of this type use hierarchical relationship structures to indicate relatedness between information units, although this is not a necessary consequence of allowing users to set up their own organizational schemes.

Organizational schemes that rely on the use of hierarchical (parent/child/sibling) structures require that the relationships between entities in a set be defined or explicitly declared, either by data entered by the user from information associated with the entities themselves. While such organizational structures may be suitable for situations in which one can draw clear hierarchical or parent-child relationships between items, not all entities requiring organization are best organized using such a model, nor do all situations call for organization structures of this kind.

In general, applications that require users to describe or denote organizational relationships may strike the user as too labor-intensive for some situations, especially for users who wish to deal with loose aggregations of information that neither have nor need clear relationships that can be readily translated into structures and relationship types used by the specific application. The burden of processing information, however, is shifted to the user. In addition, much of the value of this approach depends upon the assumptions that (a) user can, will, and should take the time to create the appropriate relatedness structures and (b) that the user will be able to choose the most appropriate organizational schemes from among the myriad groupings conceivable. Moreover, structures that are explicitly defined by the user will also tend to run the risk of being relatively static, given that updating organizational structures may require continual additional efforts on part of the user.

The application provides organized access to information by ensuring that the information captured by the system enters the system in a structured fashion.

Most applications intended to control documentation or work processes, such as document management software, asset management software, workflow, and enterprise resource planning software, require that users modify their interactions with the computer system in order to provide the system with needed indexing terms and document characteristics. In many cases, information about documents entered into such a system must be entered by the user, although efforts to automate the capture of some of the information do exist. A variation on this method is employed when multiple but related types of information resources are all created, managed, and viewed in a single specialized application, which typically stores different types of information in specially formatted records. Examples of the latter include personal information management programs such as Microsoft Outlook.™. or contact managers such as Symantec's Act!.™.

Historically, computerized environments have tended to make use of techniques that restrict or constrain user behavior in order to make user input more compliant with the requirements of processes executed in the computerized environment. Forms, particularly those with mandatory fields or input validation, are a common example of tools to control user behavior so that inputs and interactions stay within certain processable parameters. Processes can also be controlled by ensuring that users complete specified steps in a particular order. In applications used to organize information, constraints on user behavior can be used to (a) help capture access points of the specific type or format required by the system for indexing, and (b) control the flow of activity so that it conforms to a pattern that the software is designed to accommodate. Constraining or controlling user behavior hence tends to reduce the demand on the computational processes needed to process user input. Difficulties arise, however, when information falls outside the realm of the defined for a given program, or when users manage to find ways around the constraints imposed by the program.

Because the effectiveness of such systems depend at least in part upon the reduction of the variability inherent associated with the functions or entities being controlled, such systems tend to provide the most benefits if they are deployed throughout an organization, frequently with extensive customization being done to integrate the system with the applications, processes, and procedures that are used in each particular case. As a result, applications of this type are generally large, expensive, enterprise-wide systems that require the participation of all or most users plus strict adherence to procedures for interacting within the system.

Such systems are very useful for enforcing document control and ensuring adherence to procedure, and are also useful for later identification and retrieval of information related to specified projects, especially in cases where thoroughness, accuracy, and authenticity of records is required. However, such applications also tend to impose strict requirements on user behavior, with more emphasis is upon the control of the finished products and the records of the processes that create them than the support of users.

The application automates the organization of information, requiring minimal user interaction in order to set up organizational groupings.

Given the labor intensive nature of organizing work, methods to automate the organization of information resources are generally seen as highly desirable, despite the possibility that automated methods may not provide structures as meaningful as those that might be created by users themselves. Automated approaches to organizing information often employ methods that depend on the processing of large quantities of data in order to produce potentially meaningful groupings of information, although the processing of large quantities of data is not a necessary characteristic of this approach.

In general, the groupings are typically created not by storing the information in the same or nearby physical locations (although this can be done), but by analyzing and indexing the information resources being made accessible. Entities such as documents, database records, applications, or individual data elements are analyzed in order to extract information that can then be used to provide access points for retrieving information. Access points used and indexed may be part of the content of an item, such as words or tagged text within the text of an item, or they may be non-content characteristics, such as time of creation or modification, the source application, author, geographic location of creation, assigned keywords or assigned codes such as project codes or subject headings. Records of activity relating to the item, such as usage or viewing statistics, can also be recorded and indexed. Non-content characteristics of information sources are sometimes referred to as metadata, or sometimes “contextual metadata” when referring to characteristics that help define an entity's relationship to time, space, actors, or other entities or parameters.

Many methods for automatically indexing and classifying entities have been proposed in the prior art. All methods use one or more indicators of some characteristic of the entity that could then in turn be used to produce groupings or measures of relatedness or relevance. Entities and interactions may be grouped by methods that ostensibly create groupings that have common subject matter, or they may be grouped by methods that show relationships to time, place, persons, entities, actions, or interactions.

The most well known and frequently used methods of automatic classification are based upon the analysis of the content of documents, such as keyword indexing. More sophisticated techniques may include statistical analysis of content, such as word co-occurrence analysis, or analysis of the content of items for text patterns indicative of specific content—for example, dates, proper names, or Internet URLs. The latter type of method is especially suitable for documents where specific types of content are explicitly marked, such as documents written in SGML, XML, or HTML. Note, too, that item content may also be used to produce indicators that are not strictly subject-oriented—for instance, information about the item, such as date of publication, authorship, or physical characteristics, may be part of the content. Some existing methods also make use of explicit references to other documents, such as document links in HTML documents, which, in addition to being content, may also indicate relationships between the referring item and the referents.

Other commonly used methods of establishing relationships between resources include methods that use non-content data that is directly associated with an item in order to perform grouping and sorting operations. Data such as the creation date of a document or piece of data, the author of a document, applied subject headings, the location of the document's creation, the application within which a document was created are all examples of data that need not be part of a document's content but are nevertheless part of a document's description. In current jargon, such data is sometimes referred to as metadata (data about the data), or sometimes “contextual metadata”, in recognition that the metadata doesn't so much tell us about the actual contents of a document or data element, but about its context that is usually conceived of as time, place, and origins. In a computerized environment, documents and other data elements usually may have associated metadata elements that don't necessarily appear as part of the document, but nonetheless are directly associated with the document.

In general, current automated methods are focused upon reducing the amount of effort required to generate and populate relatively static structures that have been pre-determined by the designer of the automated method. Thus, for automated systems, the appropriateness of the groupings or retrieval results depends upon the appropriateness of the measures and indicators chosen by the designers to organize access. The choice of measures and indicators, in turn, is determined by assumptions and predictions that designers make about the needs and desires of their users, the contexts within which those needs are to be addressed, and even the ways in which the users see and interact with the world and the relationships within it. Unfortunately, while designers can make their best guesses about how the world might be most sensibly organized by a user, the fact remains that no one scheme is likely to be appropriate for all users in all contexts, nor even for a given user over different contexts. Subject groupings; for example, are frequently appropriate, but not always so. Moreover, the assumptions made by the user about the appropriate parameters for grouping by subject may differ considerably from that of the designer, as studies of classification behavior have shown. Similar arguments may also be made for systems that group or organize access according to other indicators of relatedness, such as time, geographic location, physical characteristics, or reference. As a result, automated methods meant to be responsive to user needs are frequently only truly successful within a limited domain anticipated and predicted by the designer.

Retrieval and Presentation of Information

The other aspect of providing organized access to information is the retrieval and presentation of information to the user. The basic approaches are:

Retrieval and presentation of information in response to specific requests by the user.

This approach requires the user to initiate a request for the information, either by entering a request for a specified search, or by selecting a request (such as an option from a list, or a hyperlink on a web page). As with other user-driven methods, the burden is placed upon the user for recognizing a need for information and executing an adequate query.

Providing access to a pre-coordinated, substantially persistent grouping of information, information resources, or pointers to information resources.

Within the context of this application, “pre-coordination” refers to the “prior putting together” of elements of a multi-component item or set. Pre-selected and pre-grouped sets of information may be created by the user, generated by an application, generated by a party other than the user, or some combination of these. The groupings of information resources are pre-selected to form groups that are expected to be of relevance to the user. Perhaps the best examples of this approach can be found on the World Wide Web, as pages or sites that aggregate and present hyperlinks relating to particular disciplines, subjects, or interests. Some portal-creating applications, such as Enfish Onespace, also provide access to the contents of users' own resources, such as their local devices and networks. Such resources are sometimes termed “information portals” and are often at least somewhat customizable by the user. They can also contain variable information that changes according to changes in external information sources, such as news feeds or movie listings, or even lists of recently accessed documents.

Pre-coordinated groupings and displays of information are only useful to the extent that the selected groupings anticipate user needs. Once again, the success of the system depends upon the extent to which the assumptions made in designing the system anticipate the actual needs of the user in any given time or context. Responsiveness to immediate user needs can thus be an issue and may require other features (such as a search function) to address the need to address the current needs of the user.

Retrieval and presentation of information in response to detected conditions or specific actions by the user, independent of explicit user requests for information.

This basic approach is a natural outgrowth of the potential of the computerized environment automating the gathering and retrieval of information. Automated help systems that automatically present potentially relevant portions of application documentation in response to user activity are well known implementations of the approach, as are features that automatically complete or automatically suggest additions or actions in response to particular kinds of user input. The automatic presentation of information may be further modified by past interactions with a system or explicit feedback provided by the user.

Methods which automatically retrieve and present data to the user based on detected conditions vary in the conditions or parameters used to initiate retrieval and presentation, as well as in criteria used to determine what information should be presented to the user in response to a given condition. The general approach for triggering automated search and retrieval is to monitor indicators of the user's current activity or focus. Indicators of the user's current context or environment may also be monitored, for methods where such factors may be relevant for information retrieval. Well-known methods include: monitoring user input for specific keystroke sequences, such as those for specific words or phrases; monitoring time, such as time of interaction; monitoring physical location (for systems that are integrated with Global Positioning sensors, for example, or other physical location sensors); monitoring indicators of user focus or attempts by the user to access specific types of information, for example, clicking on hyperlinks, cursor placement or mouse clicks in a graphical user environment, system information indicating the identity and characteristics of the currently active document, application, or other aspects of the operating environment.

Automated systems of this type may make use one or more different methods for determining what information will be retrieved and presented. The methods and types of parameters used in the retrieval and manipulation (e.g., sorting, relevance ranking) of information will of course vary with the intended purposes of the system or application. Once again, the appropriateness of the results produced by such systems is dependent upon the extent to which designers can anticipate and predict the needs and behavior of the user, and the extent to which the measures chosen can accommodate variability across and within users in different contexts.

In general, existing methods for organizing and providing access to information, resources, people, and other entities seem to be caught between two approaches: those that shift the burden of creating organizational structures onto the user, and those that attempt to assist the user by incorporating automation. Despite the obvious potential advantages of automation, particularly in fast-paced, data-rich, and complex environments, the continuing emergence and utilization of tools that depend upon the former approach indicates that current automated methods are falling short of meeting the needs of users.

Particularly, methods that ask the user to explicitly declare the existence of relationships, or explicitly add significant information, can be more successful in creating meaningful access than methods that rely solely upon the content of an item or its readily observable characteristics, despite being more labor-intensive.

Clearly, there is still a need for methods and systems that address user needs for organized access in a variety of contexts while also imposing as small a burden as possible on the user.

### SUMMARY OF THE INVENTION

The present invention provides users with means for obtaining organized access to information, resources, persons, and other entities that may be related to a user's current focus of attention or activity. In particular, the present invention provides such support for users within a context that includes a computerized environment, whether or not the computerized environment comprises the entire context within which interactions take place.

In a preferred embodiment, the present invention enables a user to access information that is, from the point of view of the user, simple, flexible, and responsive to changing needs, context, and focus. Such organized access minimizes the burden on the user to explicitly provide information to the system to assist in the production of organized access, and adapt to the system. The present invention provides for the creation of methods and systems that adapt to users, rather than forcing users to adapt. In particular, systems incorporating the methods of the present invention are expected to be particularly beneficial in that the user is able to focus on their chosen activities or projects, rather than diverting energy and focus to activities aimed solely at feeding, maintaining, or adapting to the organizing system.

In a preferred embodiment, the present invention provides methods and systems for providing organized access to information, resources, and other entities, enhancing user awareness of entities and interactions relevant to a chosen focus while minimizing interference with the current focus or activities of the user. Advantageously, the present invention can assist users by elucidating, revealing, or reminding users of relationships between entities and interactions, providing the user with opportunities to discover meaningful or useful relationships that may not otherwise have been obvious. Also advantageously, the present invention can also provide a means for providing convenient access to related or potentially helpful entities and interactions, either by displaying relevant content of the referenced information resource without requiring the user to launch the original application, or by allowing the user to directly open the information resource associated with the referenced entity or interaction.

A preferred embodiment also includes methods and systems for providing access to, and displaying entities or interactions (or representations of them) that are likely to be associated with a particular activity or project, again with a minimum of user intervention. Also, the present invention, in a preferred embodiment, provides methods and systems for organizing access to entities and interaction in terms of relatedness, where at least part of the relatedness is measured in terms of parameters relevant to user getting things done, or to the activities of the user. Ideally, the present invention would provide users with the benefit of easy access to information directly relevant to their activities, even when the focus of these activities is rapidly changing.

A preferred embodiment of the present invention provides a system for providing access to information that is responsive to changes in user focus. Advantageously, systems developed according to the methods of the present invention would automatically re-orient around the current focus of the user's activity, in order to allow the user to quickly adapt to changes in task or priority.

A preferred embodiment of the present invention provides the value of organized access to information resources to individual users without requiring extensive integration of the system with other applications and systems employed by the user, requiring that other users use the same system, or requiring that all or most interactions with resources so organized occur via interactions mediated by the system.

In another preferred embodiment, the present invention provides a method for assessing the probable relatedness of documents that is not solely derived from parameters directly associated with the entities and interactions being organized, including explicitly defined characteristics of the entities and interactions. Moreover, a method is provided in a preferred embodiment for assessing the probable relatedness of documents that is at least partly related to user activity.

In a more specific domain, the present invention provides a simple, adaptable method of quickly aggregating and retrieving documents, messages, contact information, and other information resources associated with a particular project or activity focus, particularly for those instances where strict adherence to item control or adherence to procedure is either not desired, or unnecessary.

The present invention provides users with tools for gaining insight into the context of individual entities and interactions, particularly in a computerized environment. These method and systems allow users to focus on a chosen task by making related entities and interactions accessible to the user without requiring the user to switch focus by having to actively search for and retrieve such information. The present invention also provides tools that enhance user productivity.

In accordance with an aspect a preferred embodiment of the present invention, user interactions within a computerized environment are analyzed in order to collect data about user activity. Indicators of user focus, derived from data relating to user activity, are then used to make inferences about probable activity focus. The data may be collected by monitoring user activity in real-time, or may be extracted from data collected by other sources, such as other software applications. Either or both of these approaches may be used. At least some of the data collected is collected without requiring explicit user input; preferably, the system does not require the user to enter any explicit declarations or indicators of current activity. It may, however, be advantageous for the user to be able to provide such data as an option. Advantageously, more than one method of data collection will be used.

This data collected is used to produce indicators of relatedness between entities in the user environment, including entities which describe actions and interactions occurring between other entities. The methods used to produce measures of relatedness between entities are selected with an emphasis on predicting or providing estimates of common activity focus. The indicators of relatedness used may be extracted directly from existing information, or derived from manipulations involving the collected data. Advantageously, systems employing the method of the present invention will use data of more than one type and source, combining one or more of data extracted from the content of the item, data about items stored with or separately from the items, data extracted from user interactions with the computerized environment, and data entered directly into the system by the user, in addition to data derived from manipulations involving the collected data.

In another aspect of a preferred embodiment of the present invention, indicators of current user activity focus are used to retrieve data about entities or representations of entities and make them accessible to the user. In accordance with this embodiment, user interactions within a computerized environment are monitored for events indicating changes in user focus. The exact events monitored are selected for their association with behaviors that are associated with changes in user focus. When such events are detected, the data relating to the identity of the entity that is deemed to be the object of the current user focus is used to retrieve data about entities with indicators of relatedness that indicate some amount of common activity focus. The data is retrieved automatically in response to events indicating a change in user focus; the user is not required to enter an explicit request to retrieve the information. Entity information retrieved as a result of using this method are presented to the user through a user interface. Advantageously, the user interface will include a graphical display of representations of the entities, more or less collocated in order to provide convenient access to the user. Preferably, the retrieval and display methods will allow for rapid re-orientation and display of information in order to keep up with rapid changes in user focus.

Additionally, further advantages can be realized by allowing the user to directly access the displayed entities through the user interface presented, without requiring the user to switch focus. Examples of such direct access will be described in the preferred embodiment. Advantageously, the user interface may be structured in order to organize the presented entities into groupings that reflect different differences in the ways in which the user may be expected to interact with particular entity types. Thus, in a working context in which a user works with files, persons, and communications in a computerized environment, the entities presented may be advantageously grouped into groupings of files, persons, and communications, each of which are associated with fairly consistent sets of interaction and action types, and are typically characterized by similar descriptive parameters within a group. Advantageously, the number of types of entities and interactions monitored may be less than the total number of types of items that may be potentially monitored. Provided that the selected types of entities and interactions are the types of most concern to the user, this selective approach can reduce the amount of competing stimuli making demands upon the user's attention and resources, while providing access to those entities that provide the most value.

In another preferred embodiment of the present invention, the system is utilized for determining relationships between the entities or information resources in a computerized environment as a stand-alone system or integrated with other applications. The system of this preferred embodiment is able to determine relationships between information resources by both explicit means through similarities in characteristics and content of the information resources and by inferring relationships by other similarities, including but not limited to indirect data, observations, attributes, assumptions and other means.

These and other features of the present invention will be better understood from the more detailed description following, along with the drawings and the accompanying claims.

### BRIEF DESCRIPTION OF THE DRAWINGS

FIG. 1 is a schematic illustration of a physical implementation of a preferred embodiment of the present invention.

FIG. 2 is a screenshot of an example of the use of the embodiment of FIG. 1.

FIG. 3 is a schematic illustration of the data collection of the embodiment of FIG. 1.

FIG. 4 is a screenshot of the information collection process of the embodiment of FIG. 1.

FIG. 5 is a screenshot of the graphic user interface of the embodiment of FIG. 1.

FIG. 6 is a screenshot of the graphic user interface in the example of FIG. 2.

FIG. 7 is a screenshot of the graphic user interface display showing the pointers to emails relating to the example of FIG. 2.

FIG. 8 is a screenshot of the graphic user interface display showing the pointers to documents relating to the example of FIG. 2.

FIG. 9 is a screenshot of the graphic user interface display showing the pointers to contacts relating to the example of FIG. 2.

FIG. 10 is a screenshot showing the editing function of the system of FIG. 1.

FIG. 11 is a schematic of a specific implementation of the embodiment of FIG. 1.

### DETAILED DESCRIPTION OF A PREFERRED EMBODIMENT

The present invention, in a preferred embodiment, provides methods and systems for organizing access to resources and materials. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

The descriptive preferred embodiment discussed herein utilizes an embodiment of the present invention on a single user personal computer. It is to be expressly understood that other environments could be used as well, including but not limited to desktop computers, laptop or notebook computers, personal digital assistants, combination telecommunication devices, handheld computers, wireless communication devices, wearable computing devices, global positioning devices (alone and combined with other devices) and other electronic devices. Additionally, the present invention is intended for use with networked devices as well, not only in local area networks, wide area networks, wireless networks, virtual private networks, the Internet and any other type of interconnected devices.

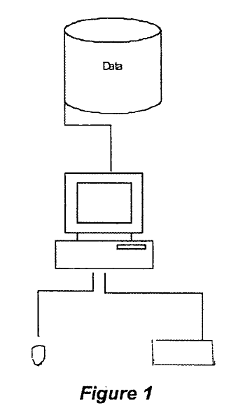

FIG. 1 shows a schematic view of the descriptive preferred embodiment of the present invention. The system 100 of this descriptive preferred embodiment is installed on a personal computing device 10 operated by a user. This personal computing device includes an input device 12 (keyboard, mouse, microphone or any other type of input device presently in existence or later developed) and a monitor 14. The computing device 10 includes or is connected to a storage device 20. The storage device 20 stores and maintains data files operated on by the user or other users.

It is to be expressly understood that while in one preferred embodiment, the system not only organizes access to information resources, it also displays the organized information on a display for viewing by a user or other individual. However, the organized information may also be utilized in other manners not requiring display. For example, and without limitation, the system of a preferred embodiment may open applications, files or other information resources that may be related to a particular user activity focus.

Also, in other preferred embodiments, the system operates without user intervention. That is, the system operates transparently such as interacting with the operating system and the only time that the user is aware of the operation of the system is when information is displayed or otherwise provided to the user. Alternatively, the system may also operate only when requested by the user.

The system of a preferred embodiment of the present invention includes several components, such as a component for collecting data relating to information resources, a component for determining relationships between information resources, a component for collecting data regarding the user activity and a component for inferring the user activity focus. It is to be expressly understood that the system is not limited to these components, that the system may use less than all of these components and that any one of these components may be utilized in other embodiments of the present invention either alone or in combination with the other components or other components that are not expressly identified.

A typical preferred embodiment of the present invention is described herein to provide understanding to the present invention. Again, it is to be expressly understood that this descriptive embodiment is intended for explanatory purposes only and is not meant to limit the scope of the claimed inventions that may include the elements of this descriptive embodiment, additional elements, differing combinations of these elements, or the elements alone.

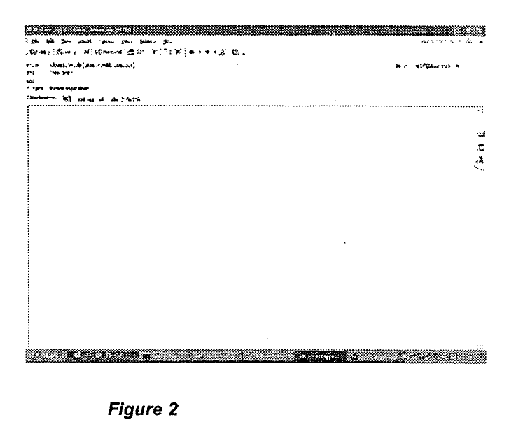

Generally, as the user begins, modifies or otherwise interacts with a program on the personal computing device 10, such as a word-processing program, spreadsheet program, email program, or any other type of program, the system 100 of the descriptive preferred embodiment of the present invention monitors the interaction and provides unobtrusively suggestions of related resources for the consideration of the user. For example, as shown in the screenshot illustrated in FIG. 2, the user is working on a document that has a subject heading referred to as Project that is to be emailed to John Smith. The system 100 provides information to the user by way of a graphic user interface 110 regarding files in the storage device 20 relating to the Project subject, as well as files in the storage device 20 relating to John Smith. These files may include text documents, spreadsheets, website pages, graphic images, voice, video, music, email messages, contact information, and other types of informational files. The user may retrieve any or all of the displayed files directly or simply ignore the display.

The system 100 of the descriptive embodiment is also able to provide a reference as to the “quality” of the information as well as the quantity. There are numerous methods for determining the quality of the information, i.e., the type and number of relationships to the information, the degree to which the information is related to the active user focus, as well as many others. In the descriptive embodiment, the graphic user interface 120 includes an icon 122 that indicates the quantity of information that has been retrieved as relating to the activity focus.

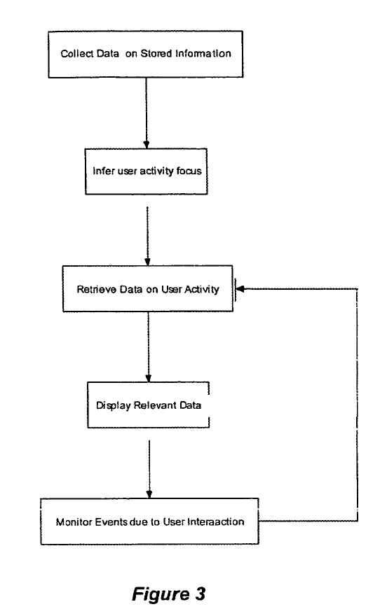

The system 100, in the descriptive embodiment, provides the contextual information implicitly, without the need for user intervention. In this preferred embodiment, as shown in the schematic shown in FIG. 3, the system 100 first collects data regarding the information in the storage device 20. The activity focus of the user is also inferred by the system 100. Then data is retrieved regarding the activity of the user. The system displays relevant data by way of a user interface display. The system 100 monitors the events occurring due to the interaction of the user and the computer system 10. Thus, the system 100 is able to determine when the user changes activity focus, retrieve data relevant to the new focus and display that relevant data. The organization of the information may be accomplished in a hierarchical format or, in the preferred embodiment, in a non-hierarchical manner.

Definitions

Within the text of this specification and the claims that follow, a number of terms will be used to refer to various aspects of the invention. For the sake of clarity, a number of key concepts are defined and clarified below. Additional definitions will be provided where appropriate in the text of the specification.

Information Resources (also referred to as Entities) This term will be used to broadly refer to things such as units of information, resources, objects, or people. Information resources, also referred to herein as entities are referred to by nouns, but are otherwise not restricted in their characteristics. Thus, entities may be persons, groups of persons, or corporate entities; they may be ideas, physical objects, or computational objects; they may be corporeal or non-corporeal; living or nonliving; active or inactive; moving or nonmoving; mutable or not. Examples of entities may include persons, tools, software applications, files, facts, records, or communications. Some entities can only be objects of actions; other entities may be considered agents or actors, entities which can perform actions that affect other entities. Entities that are actors can include individuals, committees, and loose associations of individuals, or corporate entities such as companies, as well as entities which may not fit the conventional understanding of persons, such as software-based intelligent agents or “bots”. Actors may also be objects of actions as well. Entities may also be representations of other entities, proxies for other entities, or pointers to the location of other entities.

Interactions This term will be used to refer broadly to occurrences that relate two or more entities by virtue of an action. Note that interactions and actions may be referred to by entities, and may thus in some senses be represented by entities.

User This term will be used as the generic term for the entity that is intended to use and benefit from the present invention. The user engages in activities and can initiate or participate in interactions with other entities. Within the context of this document, the term “user” may refer to individuals, or to groups of individuals, collectives, or corporate bodies (e.g., a company, a city, an institution, or an organization). Thus, an organization can be considered a user, as can an individual. It is not assumed that users are persons, although in practice it is expected that most users will be either persons or groups of persons.

Focus A dimension around which entities and interactions can be oriented, or described with reference to or between the entities and interactions. Common types of focus include subject focus, where entities (and sometimes actions and interactions) are described with respect to temporal focus, where entities, actions, and interactions are described with respect to their relationship in time; spatial focus, where entities, actions, and interactions are described with respect to their relationship in spatial location; and activity focus, where entities, actions, and interactions are described with respect to their relationship with respect to the actions and interactions comprising activities.

User focus The objects, interactions, or actions to which the user's attentions are directed. User focus is not directly observable to entities other than the user; however, indicators of user focus can be derived from self-reports by the user, or from observations of user behavior. Observations of user behavior can directly provide indicators of user focus, or they can be used to derive or make inferences about probable user focus.

Activity Focus All activities shall be understood as interactions between entities (or collections thereof) which originate as a result of the actions or behavior of actors. Specified groups of entities and interactions may be united by a common focus, the activity focus, around which all the entities, actions, and interactions are oriented. Most commonly, the activity focus can be described in terms of orientation towards a goal.

The focus of an activity may be known to the user or observers, as when the user is working on an explicitly defined goal or project, but nature of an activity focus need not be recognized in order for it to exist. Thus, there may be instances when the focus of the activity may only become apparent after time or observation. Multiple activity foci may also all relate to a common activity focus; for example, the various tasks associated with are project are all activity foci, while the project itself is an activity focus as well.

Access The term “access” encompasses the provision of both direct and indirect means to interact with specific entities. The interaction can be physical, mental, or computational. Thus, the term also includes the notion of “access” in the sense that the entities are made more readily available to one's attention. (This could be conceptualized as the provision of means to interact with representations of entities, where the representations being interacted with are ideas about the entities.)

Access point The noun phrase “access point” is used to refer to a parameter associated with an entity that is used to retrieve the entity or a representation of it. A subject description applied to an entity may be used as an access point, for example, as can the time of a document's creation, a person's last name, a usage statistic, or a calculated measure based on other parameter. An access point need not be directly derived from the content or observable characteristics of an entity; access points may be applied by users or maintainers of an organization and retrieval system, or by the system itself.

Organizing Access The phrase “organizing access” will be used to refer to the process of making entities and information about actions and interactions accessible to the user by making additional information about the relatedness of the entities, actions, and interactions at least partly available to the user, and by providing means for using the additional information to retrieve items or information about items. Note that the user need not see all the additional information used to denote or indicate relationships between items; however, the additional information that is shown should provide the users with sufficient information to decide between the items that they can choose to access. This additional information may be information about the structure of the relationships, as could be provided, for example, by hierarchical outlines, taxonomies, Venn diagrams, or physical grouping of items or their representations. Another way of organizing access, and thereby providing additional information about relatedness, is by associating additional information with items, such as keywords, subject headings, date or time stamps, author information, or usage data. This application of additional information is usually termed indexing.

Relationships Where the terms “relationship” or “relatedness” are used, they should be understood to mean relatedness in its broadest sense, without restriction to a specific type of relatedness unless specified. The various kinds of relationship that can be described between items are theoretically infinite, but some will tend to be more useful to users than others. Examples of commonly recognized types of relationships include:
lineage (parent/child/sibling relationships)
structural similarity
similarity of content
similarity of function
similarity of applied metadata (time, creator, location, applied subject keywords)
linkage by reference

Note that these are only examples of possible kinds of relatedness; the list is meant to be illustrative, rather than exhaustive. It is to be expressly understood that in a preferred embodiment of the present invention, these relationship need not be in a hierarchical form.

Inferred Relationships The present invention also makes use of “inferred relationships”, which, rather than being taken directly from items or their descriptions, are inferred or deduced based upon observations combined with other observations, assumptions, or knowledge about the items being related. Inferred relationships may or may not exist between the actual items being related; they are by nature inherently uncertain as the information used to create them are not derived solely from the characteristics or content of the items being described. They often depend upon chains of observations and are generally more tentative and subject to change based upon the addition of additional observations (history). Assumptions of similarity based upon other measures of similarity generally produce inferred relationships; the inference depends upon the assumption that one kind of similarity is an indicator of another kind of similarity.

Examples of Inferred Relationships Include:
Similarity of function or use: A frozen banana, a stone, a shoe, and a hammer may, in some contexts, be related by similarity of function, in that they can all be used to bang on upon objects with some force.
Cause and effect: A series of events that appear to be related to each other via cause and effect are linked to each other by inferred relationships, which are based upon our assumptions about the nature of causation.
Similarity of activity focus

Computerized Environment The present invention is directed primarily at activities which occur at least partly within the context of a computerized environment. A computerized environment is any context in which actions and interactions between entities are mediated by computational operations which are in turn mediated by interactions between physical entities. The most recognized computerized environments in contemporary life are based on electronic devices such as personal computers, computer networks, or portable computing devices such as wearable units and handhelds. However, it should be noted that computerized environments do not need to be electronically based, nor do they need to be based upon Boolean logic, as common as these configurations may be at present. Computerized environments can also include contexts in which the presence or participation of computer devices are less obvious. Examples include “smart houses”, for instance, where sensors monitor aspects of a physical environment and process information relating to those aspects; motor vehicles with on-board navigation computers; mobile phones; wireless information networks, and “smart appliances”.

Specific Operation

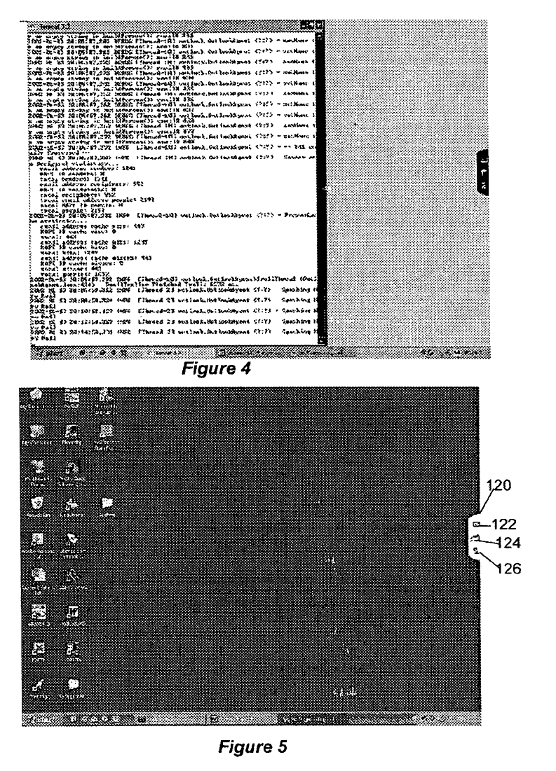

The system 100, in the descriptive preferred embodiment, includes a “Trolling Agent”, that collects data regarding information resources (information resources encompasses “entities” as defined above) on the storage device(s) (or other sources for such information resources, including but not limited to, information resources stored on other computers, networks, the Internet, etc.), in email applications, directories (address, contact, and others) and other sources that may contain relevant information resources. Initially, the Trolling Agent uses information that predates the install of the system to determine relationships among the data it analyzes. The Trolling Agent, in this embodiment, is activated automatically upon installation of system, periodically during the operation of the system or upon user selection. The Trolling Agent reviews not only the files in the system but also information with in email programs, directories, and other applications. Previous systems reviewed only the files and information about the files (file type, file size, date created, etc.) or by analogy, information “nouns”. The present system also generates inferred and explicit relationships among the files and emails it reviews. The Trolling Agent is able to accomplish this by way of Relationship Operations as discussed in detail below. This information may be stored by the system 100 and constantly updated in the background operation of the computer 10. An example of the results of the Trolling Agent is shown in the screenshot illustrated in FIG. 4.

The system 100 also includes an operating system watcher (“OS Watcher”) that monitors the actions of the user and the operating system to determine the activity focus and user usage patterns. When the user interacts with the computerized environment 10, the actions of the user directly or indirectly generate events or conditions that can be monitored by the OS Watcher. For purposes of this descriptive embodiment, events are defined as changes in the current state of the environment. Conditions are defined as existing characteristics of entities. Examples of events that may be monitored include keystrokes, mouse clicks, cursor movements, spoken commands, function calls, and error message generation, as well as file manipulations such as the creation, modification, deletion, copying, or moving of documents or messages. Examples of conditions that may be monitored include the activity status of open application windows in a graphical user interface, opening of a file, closing of a program, etc. Note that the events or conditions that may be monitored in computerized environment 10 will vary with the exact configuration of the environment. The events and conditions listed by examples here are by no means intended as a comprehensive list.

Of particular relevance to the present invention are events and conditions that may be used to obtain indicators of user actions and focus. Again, methods for obtaining indicators of user actions and focus will vary depending upon the characteristics of computerized environment 10 and other details of the context within which the user is working. Examples of methods that could be used include:
detection and identification of the topmost window in a graphical user interface
detection of modifications being applied to a file or record; identification of file or record
movement of cursor to vicinity of an item
in point and click systems, clicking on visual representations of items
keystroke sequences corresponding to names or portions of names of specific entities
commands entered by a user; identification of entities referred to by commands
exporting files
saving email attachments
saving versions of a file
saving renditions of a file

It is to be understood that the system does not necessarily monitor direct evidence of user actions or focus, but may monitor only indicators that can be used infer user actions and focus.

Certain indicators of user focus are chosen as triggers for information retrieval. In the descriptive preferred embodiment, these should be those that are most like an explicit request from the user to display or retrieve a specific item. Examples: clicking on a file to open or retrieve it, entering or selecting a name of a person or a file from a list, dragging and dropping a file into an application window.

Other indicators of user actions may be less certain, but nevertheless can be profitably logged and analyzed in order to produce additional measures of the relationships between entities, which can then be used to produce indicators of probable relatedness with respect to activity focus. Such indicators include: concurrently opened documents might be in common.

In a preferred embodiment, the system 100 is designed for use in a computer environment with a graphical user interface 120. It is to be expressly understood that other types of information display or utilization of information may be used as well. In the preferred embodiment, system 100 reports information to the user through graphic user interface features 120 that are displayed using visual display unit 14. In the preferred embodiment, graphical use interface 120 segregates the information into three categories at display 122. These categories, in this embodiment, include communications 124, documents 126 and contacts 126. Of course, other categories may be used as well. These categories include icons as well as indicators as to the quantity of information in each category. The graphic user interface 120 also includes a pop-out display window 128 that displays pointers 130 to entities identified by system 100 as being related to the current user focus.

Preferably, graphic user interface feature 128 will include displays of additional information about the entity listings that may be useful to the user, for example: time of entity creation, location in the computerized environment, format, associated actors (e.g., author or generator), document content or selected portions thereof, or nature of the relationship used to determine that a given entity is related to the current user focus. Preferably, the entity considered to be current user focus will also be displayed.

Ideally, preferred embodiments of the invention should allow the user to open or manipulate the displayed entities without having to switch applications or switch focus. One way of implementing this in the preferred embodiment is to allow users to manipulate or open displayed entities via the representations of the entities displayed in graphical user interface feature. It is important to note the entities are grouped into homogeneous collections, even though they may reside in various heterogeneous sources. For example: files that reside in email attachments are listed alongside with files that reside at other locations. Preferably, the application should also allow the user to explicitly declare or change user focus, for instance by entering or selecting specified entities via a data entry field or browse menu, or by dragging and dropping an icon representing a desired focus onto the graphical user interface feature. Methods for providing the user with means to explicitly indicate that specified entity is acted upon by specific applications are well known in the art and will not be further detailed here. In addition, the display of entities in graphical user interface feature can also be further enhanced by subdividing the display to present information associated with different types of entities separately. This optional enhancement can provide the additional advantage of aggregating items that have similar sorts of associated activities.

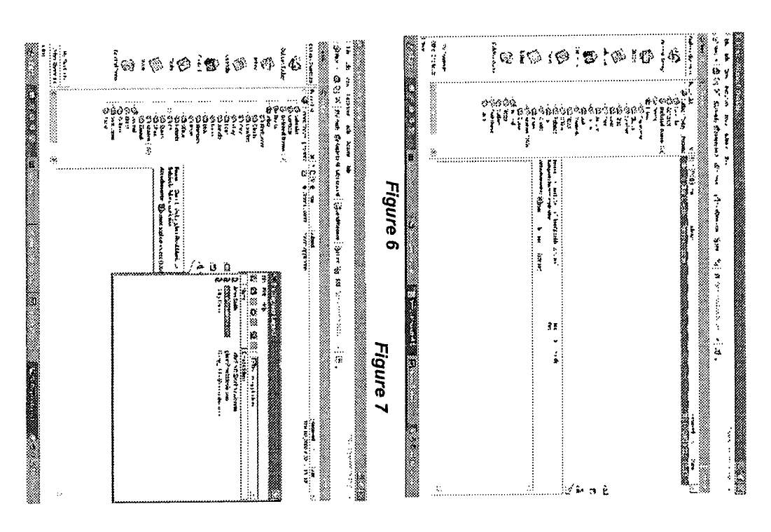

An example of this descriptive system 100 is illustrated in FIGS. 6-10. In this example, an email was sent to John Smith concerning a patent application that was attached to the email. Graphic user interface 120, in FIG. 6, indicates that there are relevant information in all three categories, communications, documents and contacts.

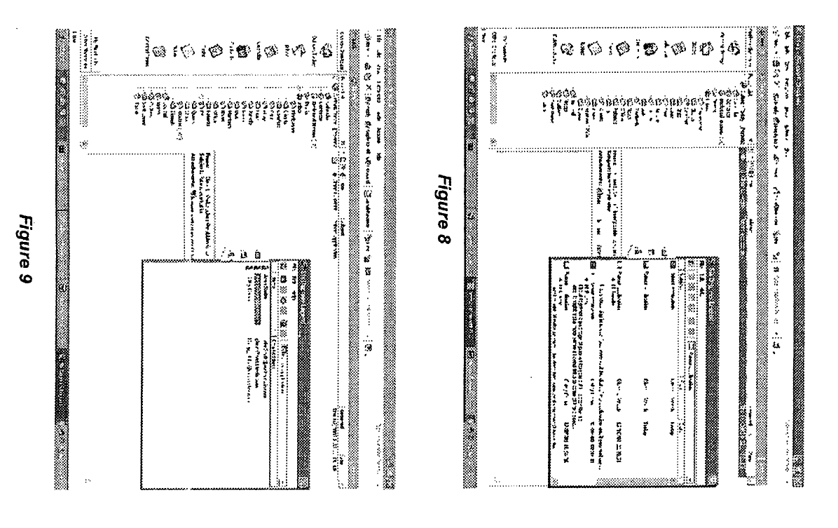

In FIG. 7, display 128 pops out to show pointers 130 to emails that may be relevant to the original email. Information about each of the emails is also displayed that allows the user to decide whether the information is pertinent to the task at hand. Similarly, as shown in FIG. 8, display 128 shows pointers 130 to documents that may be relevant to the task at hand. Also, as shown in FIG. 9, display 130 shows pointers to contacts that may be relevant to the email being sent or received.

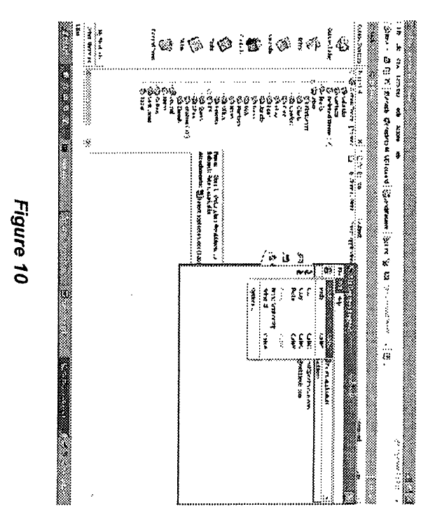

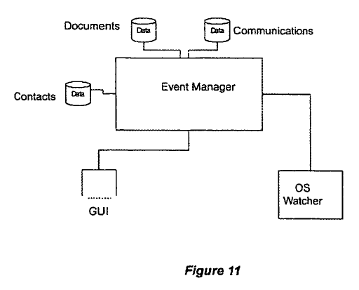

The system 100 also allows the user to intervene to add relationships or sever relationships with the activity focus. An example of these features is shown in the menu of the screenshot of FIG. 10.

When operating in the computerized environment of the preferred embodiment, system 100 performs several functions in order to provide the user with organized access.
1. It monitors entities and interactions within the computerized environment, detecting and logging information such as events, current characteristics of items, and operations performed on items by either the user or other entities.
2. It detects events indicative of changes in user focus, as well as characteristics of states indicative of current user focus.
3. It analyses user actions and entity characteristics to generate and store explicit and inferred relationships between entities
4. It uses user actions to strengthen and weaken the degree of relatedness.
5. It reports information about the relatedness of entities and interactions it has monitored to the user. Preferably, the information reported to the user is determined at least partially by indicators of current user focus.
6. It displays entities from heterogeneous sources in a homogeneous list.

In principle, all detectable entities and interactions may be tracked and accessed using the methods of the present invention. Selectivity, however, can provide value. In the current preferred embodiment of the invention, the system provides the user with access to a limited number of entity type's three basic types: files, communications, and people. These item types are selected with the intent of maximizing the information value of the entities tracked while reducing the load imposed upon the user for attending to and evaluating information. These types were chosen because the currently envisioned application of the preferred embodiment is as a tool for users who engage in project work in a computerized environment, where the primary items of interest are people (e.g., collaborators, employers, employees, or team members), our interactions with them (e.g., email communications, fax, voice mail, instant messaging, letters), and the items we work on together, which in a computerized environment will likely include at least some computer files.

It should be noted that although the preferred embodiment of the present invention presents users with organized access to files, communications, and people, alternative embodiments of the invention can track different sets of entities and interactions. It may be, for instance, that other entity types will be discovered to be of more utility for the currently envisioned application. It is also the case that different choices may be more appropriate for different applications and contexts. Thus, an application intended to provide insight into the activity of a user navigating a group of hyperlinked documents may track entities such as files, hyperlink activations, and referring documents, while an application designed for troubleshooting computer-based activity may track entities such as software applications, function calls, and system messages. Note that some entities, such as the communications of the preferred embodiment, are in fact entities that represent interactions between other entities. Records of hyperlink activations are similar in this respect, as are records of function calls.

Relating Operations

In order to determine what items are displayed to the user in response to changes in indicators of user focus, data relating to entities, interactions, and user focus is collected and analyzed and explicit and inferred relationships are generated and stored for later use in helping to calculate the relatedness of entities. According to the method of the present invention, the methods for producing measures of relatedness used are employed in order to generate measures of relatedness with respect to shared activity focus, as opposed to other types of focus such as subject, origin, time, or space. Measures used to indicate these other types of focus are used insofar as they (a) can supplement the information provided to the user and (b) be used to provide or infer information about activity focus.

Again, the exact methods used to produce measures of relatedness may vary widely depending upon the nature and context of the relevant entities and interactions. Some examples of methods, however, can be described with reference to the preferred embodiment.

In a system where the user is presented with access to information about files, communications, and people, the user will be shown the following types of relationships:
file-file
file-message
file person
message-message
message-person
message-file
person-person
person-file
person-message

Files are entities that act as storage units for recorded output that can be retrieved all at once by invoking a single reference, the filename. All parts of the file are referred to by the single filename, even if physically, portions of the file are stored in different locations. Many files of interest to a user will be document files, such image files or word processing files. Other files may be executable files, or files acting as containers for other files, such as ZIP files. Typical operations involving files include creating new files, saving files, exporting files to different file formats, importing files into specified file formats, and modifying files or characteristics of files, such as filenames.

Messages are entities that are records of communications sent between entities. In the preferred embodiment of the present invention, email communications are used as one of the primary sources of information about the degree of relatedness.

Emails are essentially records of interactions, conversations ranging from simple two-person exchanges about a single specifiable topic to complex, multi-threaded interactions involving groups of people. In this discussion of the preferred embodiment of the present invention, discussion of messages will be restricted to discussion of email communications, although it should be understood that alternative embodiments of the invention could be configured to track other types of communications; for example, voice mails, faxes, instant messaging transcripts, electronic bulletin board postings, and records of meetings or contacts. The methods described here can be extended to these alternative modes of communications as well, as all these communication types share characteristic features that can be extracted and manipulated in a computerized environment, including one or more participating actors (senders and recipients), message content, and a time of writing or sending.

Individual messages, especially email messages, may be related to larger groups of messages by virtue of being part of being part of a conversation, or a series of communications exchanged between entities as they respond to each other's communications over time. One method of grouping messages into conversations is to attempt to (a) identify an initial message that is not a reply to another message or based upon another message (e.g., a forwarded message), (b) identifying all messages that are either replies to the initial message or forwards of the initial message, or related to the initial message by virtue of a chain of replies of forwards.

A number of bases for determining file to file relationships can be discerned. These include:
Revisions: different versions of a file, saved in the same format.
Renditions: different versions of a file, saved in a different format.
Inclusions: files that are linked to or embedded in another file. Inclusions may be linked to a source file by reference, such as a graphics file that has been imported into a page layout document, or they may be embedded, i.e., incorporated into a file.
Similar names: filenames can be compared in order to provide a measure of name similarity.

Message to messages relationships may be discerned from such bases as:
Sender: The same sender in different messages.
Recipient: The same recipient in different messages.
Attachments: The same attachments.
Subject: The same subject in the subject heading.
Date and Time: Messages sent within a specific time period.

Also, permutations of these bases could be used as well.

Person to person relationships can also be determined in a similar manner.

The different permutations for files, messages and people can also be compared to infer whether there are implied relationships between the information.

A Specific Implementation

A specific implementation of system 100 is displayed in the schematic of FIG. 11. It is to be expressly understood that the system 100 could be implemented in a number of different manners. The implementation shown in FIG. 11 is only provided for descriptive purposes and is not meant to limit the claimed inventions to this implementation.

The system 100 includes an Event Manager 150 residing within the computing device 10. The event manager 150 is connected to files in the storage device 20 that includes documents, emails, contact database and other information files. The OS Watcher and Trolling Agent discussed above, operates in the background of the computer 10 and collects information about the files, and relationships, including express and implied relationships between the files and user activities. The OS Watcher 160 also watches the activities of the user, files and applications to provide active context of the user activity focus. The Event Manager then provides information relating to the current activity focus to the user by way of graphic user interface 120 that is displayed on virtual display device 14. Each of these components is discussed in greater detail above.

In another preferred embodiment of the present invention, the system is utilized for determining relationships between the entities or information resources in a computerized environment as a stand-alone system. Often, it is critical to examine information resources in a computerized environment to determine the relationships between these resources. This information may be used in any manner of uses, from organizing these information resources, to security applications, to resource management, to many other types of applications. As discussed above, the system of the above preferred embodiment is able to determine the relationships between information resources by examining data regarding these information resources. Then, explicit and/or inferred relationships can be determined from similarity of the data.

The explicit relationships can be determined by examining characteristics of the information resources and/or the content of the information resources. The inferred relationships can be determined by examining indirect data between the information resources, by comparing data other than the content of the information resources, by comparing data other than the characteristics of the information resources, by observations of the information resources, by attributes of the information resources, by assumptions about the information resources or by other indirect relationships.

The system of this preferred embodiment is able to determine relationships between information resources by both explicit means through similarities in characteristics and content of the information resources and by inferring relationships by other similarities, including but not limited to indirect data, observations, attributes, assumptions and other means. These relationships provide helpful information to users as well as for use by other applications.

It is to be expressly understood that the above descriptive embodiments is provided for explanatory purposes only. Other embodiments of the system are within the claimed inventions. Further, the system 100 can be implemented on any type of computing device that presently exists or is later developed. Also, the system 100 can also be implemented on networked devices as well as used in workgroup devices to provide a greater amount of information.

1. A method for determining relationships between information resources in a computerized environment, said method comprising:
a step for examining data regarding said information resources;
a step for determining explicit relationships between information resources by examining similarity of data between said information resources; and,
a step for inferring relationships between information resources by comparing indirect data between said information resources.

2. The method of claim 1 wherein said step for determining explicit relationships includes:
examining characteristics of said information resources for similarity between the characteristics.

3. The method of claim 1 wherein said step for determining explicit relationships includes:
examining the content of said information resources for similarity between the content.

4. The method of claim 1 wherein said step for inferring relationships between information resources includes:
comparing data other than the content of said information resources.

5. The method of claim 1 wherein said step for inferring relationships between information resources includes:
comparing data other than the characteristics of said information resources.

6. The method of claim 1 wherein said step for inferring relationships between information resources includes:
inferring relationships between said information resources based on observations of said information resources.

7. The method of claim 1 wherein said step for inferring relationships between information resources includes:
inferring relationships between said information resources based on attributes about said information resources.

8. The method of claim 1 wherein said step for inferring relationships between information resources includes:
inferring relationships between said information resources based on assumptions of said information resources.

9. A system for determining relationships between information resources in a computerized environment, said system comprising:
means for examining data regarding said information resources;
means for determining explicit relationships between information resources by examining similarity of data between said information resources; and,
means for inferring relationships between information resources by comparing indirect data between said information resources.

10. The system of claim 9 wherein said means for determining explicit relationships includes:
means for examining characteristics of said information resources for similarity between the characteristics.

11. The system of claim 9 wherein said means for determining explicit relationships includes:
means for examining the content of said information resources for similarity between the content.

12. The system of claim 9 wherein said means for examining data regarding said information resources includes:
means for examining content regarding said information resources.

13. The system of claim 9 wherein said means for inferring relationships between information resources includes:
means for comparing data other than the content of said information resources.

14. The system of claim 9 wherein said means for inferring relationships between information resources includes:
means for comparing data other than the characteristics of said information resources.

15. The system of claim 9 wherein said means for inferring relationships between information resources includes:
means for inferring relationships between said information resources based on observations of said information resources.

16. The system of claim 9 wherein said means for inferring relationships between information resources includes:
means for inferring relationships between said information resources based on attributes about said information resources.

17. The system of claim 9 wherein said means for inferring relationships between information resources includes:
means for inferring relationships between said information resources based on assumptions of said information resources.
